(19) United States
(12) Patent Application Publication
(10) Pub. No.: US 2025/0235922 A1
(43) Pub. Date: Jul. 24, 2025

(54) PROCESS AIR CONTROL ARRANGEMENT FOR NECKER MACHINE

(71) Applicant: Stolle Machinery Company, LLC, Centennial, CO (US)

(72) Inventor: Stephen D. Christensen, Highlands Ranch, CO (US)

(73) Assignee: Stolle Machinery Company, LLC, Centennial, CO (US)

(21) Appl. No.: 18/417,025

(22) Filed: Jan. 19, 2024

(51) Int. Cl. B21D 51/26; B23Q 5/04

(52) U.S. Cl. CPC B21D 51/2692; B21D 51/2638; B23Q 5/04; B23Q 2220/002

(57) ABSTRACT

A process air control arrangement for controlling air provided to forming dies of a processing station. The station includes a process shaft having a plurality of openings defined at or about an end, each opening having a passage extending therefrom to a respective forming die for providing a flow of gas to the forming die. The arrangement includes a manifold housing for coupling to a frame assembly of the processing station and a plurality of manifold keys, each key being selectively positionable with respect to the housing. When the manifold housing and keys are positioned adjacent the process shaft: portions of the manifold housing, manifold keys, and a portion of the process shaft define a volume for receiving pressurized gas, and each key is selectively positioned an adjustable distance from at least one opening to selectively affect passage of air into the passage extending from the at least one opening.

### FIELD OF THE INVENTION

The disclosed concept relates generally to necker machines for use in forming can bodies and, more particularly, to process air control arrangements for necker machines.

### BACKGROUND OF THE INVENTION

Can bodies are, typically, formed in a bodymaker. That is, a bodymaker forms blanks such as, but not limited to, disks or cups into an elongated can body. A can body includes a base and a depending sidewall. The sidewall is open at the end opposite the base. The bodymaker, typically, includes a ram/punch that moves the blanks through a number of dies to form the can body. The can body is ejected from the ram/punch for further processing such as, but not limited to, trimming, washing, printing, flanging, inspecting, and then placed on pallets which are shipped to a filler. At the filler, the cans are taken off the pallets, filled, ends placed on them, and then the filled cans are repackaged in six packs and/or twelve pack cases, etc.

After being formed by a bodymaker, some can bodies are further formed in a necker machine. Necker machines are structured to reduce the cross-sectional area of a portion of a can body sidewall, i.e., at the open end of the sidewall. That is, prior to coupling a can end to the can body, the diameter/radius of the can body sidewall open end is reduced relative to the diameter/radius of other portions of the can body sidewall. U.S. Pat. Nos. 11,370,015 and 11,565,303, for example, without limitation, describe examples of necker machines upon which embodiments of the present invention improve. Such necker machines include a number of processing and/or forming stations disposed in series. That is, the processing and/or forming stations are disposed adjacent to each other and a transfer assembly moves a can body between adjacent processing and/or forming stations. As the can body moves through the processing and/or forming stations it is processed or formed. A greater number of processing and/or forming stations in a necker machine is not desirable. That is, it is desirable to have the least number of processing and/or forming stations possible while still completing the desired forming.

During formation of the neck on a can body, the can body is pressurized so as to resist damage to the can body. That is, the forming die assemblies, or other elements, are sealingly disposed in the open end of the can body and positive air pressure is applied to the enclosed space. These die assemblies, however, are disposed on a rotating shaft. Thus, the positive air pressure system must be in fluid communication with the rotating die assemblies. Generally, this is accomplished by fluid conduits that are integrated into the rotating shaft assembly and which are in fluid communication with the die assemblies. There must be, however, a rotary manifold disposed between the stationary elements of the positive pressure system, e.g., the pressure generating device/pump, and the rotating shaft. A “rotary manifold,” as used herein, means a manifold including a stationary element and a rotating element.

Present rotary manifolds, while effective, do not provide for control of pressurized air provided to the die assemblies through the forming process. Further, present solutions do not optimize usage of pressurized air, and thus do not optimize energy usage as air pressurization require a great deal of energy.

There is, therefore, a need for process air control arrangements for necker machines that provide for precise control of the pressurized air provided throughout the forming process. There is further a need for process air control arrangements that provide for optimizing air consumption during the forming process and thus energy needed to carry out such process.

### SUMMARY OF THE INVENTION

These needs, and others, are met by aspects of the disclosed concept. As a first aspect of the disclosed concept, a process air control arrangement for a processing station of a necker machine is provided. The processing station having a frame assembly and a process shaft which rotates during operation of the processing station, the process shaft having a plurality of forming dies coupled thereto and having a plurality of openings defined at or about an end thereof, each opening having a passage extending therefrom to a respective forming die of the plurality of forming dies for providing a flow of gas from the opening to the respective forming die. The process air control arrangement comprises: a manifold housing; and a plurality of manifold keys, each manifold key selectively positionable with respect to the manifold housing, wherein the manifold housing is structured to be fixedly coupled to the frame assembly, and wherein when the manifold housing and the manifold keys are positioned adjacent the process shaft: portions of the manifold housing and the manifold keys along with a portion of the process shaft define a manifold volume structured to receive a supply of pressurized gas via an inlet, and each manifold key is selectively positioned an adjustable distance from at least one opening of the plurality of openings so as to selectively affect passage of air into the passage extending from the at least one opening from the manifold volume when the supply of pressurized gas is received by the manifold volume.

Each manifold key may be selectively positionable with respect to the manifold housing via an adjustment arrangement. The adjustment arrangement may comprise an adjustment screw. The process air control arrangement may further comprise a key adjuster selectively moveable among the adjustment screw of each manifold key of the plurality of manifold keys, the key adjuster structured to selectively engage and rotate each adjustment screw.

The manifold housing may comprise: a main body portion having a number of apertures defined therethrough, wherein each aperture has at least one manifold key of the plurality of manifold keys slidingly engaged therein; and an outer skirt portion extending from the main body portion to a distal end, the distal end of the outer skirt portion being structured to sealingly engage the process shaft. The manifold housing may further comprise an inner skirt portion extending from the main body portion to a distal end, the distal end of the inner skirt portion being structured to sealingly engage the process shaft. The number of apertures may comprise a single aperture with all of the plurality of manifold keys slidingly engaged therein. The number of apertures may comprise a plurality of apertures. Each aperture may have only one manifold key slidingly engaged therein.

The process air control arrangement may further comprise a retention plate and a plurality of adjustment screws, wherein each adjustment screw is engaged among the retention plate and a respective manifold key of the plurality of manifold keys in a manner such that when the manifold housing and the manifold keys are positioned adjacent the process shaft, rotation of each adjustment screw about an adjustment axis thereof provides for the selective adjustment of a separation distance between the respective manifold key and a face of the process shaft. The process air control arrangement may further comprise an adjustment arrangement structured to selectively adjust each adjustment screw of the plurality of adjustment screws. The adjustment arrangement may comprise a first positioning motor structured to engage a second end of each adjustment screw opposite a first end engaged with the respective manifold key via a suitable engagement arrangement in a manner such that each adjustment screw may be selectively rotated via the first drive motor. The adjustment arrangement may further comprise: a second positioning motor, and an actuator; the engagement arrangement may include: a central member structured to be rotatably coupled to the frame assembly so as to be rotatable about a common axis with the process shaft; a carrier member slidably coupled to the central member so as to be slidable along the central member but otherwise fixed therewith; and an adjustor spindle carried by, and rotatably coupled with the carrier member; the second positioning motor being operatively coupled to the carrier member so as to provide for selective rotation of the carrier member about the common axis to position the adjustor spindle in axial alignment with a selected adjustment screw of the plurality of adjustment screws; and the actuator being operatively coupled with the carrier member so as to provide for selective translation of the carrier member on the splined member along the common axis.

As another aspect of the disclosed concept, a processing station for a necker machine is provided. The processing station comprising: a frame assembly; a process shaft rotatably coupled to the frame assembly, the process shaft structured to rotate during operation of the processing station; a turret fixedly coupled to the process shaft, the turret having a plurality of forming dies coupled thereto; and a process air control arrangement such as described above and herein.

As yet a further aspect of the disclosed concept, a necker machine for necking can bodies is provided. The necker machine comprises a plurality of processing stations such as described above and herein.

### BRIEF DESCRIPTION OF THE DRAWINGS

A full understanding of the invention can be gained from the following description of the preferred embodiments when read in conjunction with the accompanying drawings in which:

FIG. 1 is a perspective view of a necker machine in accordance with an example embodiment of the disclosed concept;

FIG. 2 is another perspective view of the necker machine of FIG. 1;

FIG. 3 is a front elevation view of the necker machine of FIGS. 1 and 2;

FIG. 4 is a schematic cross-sectional view of a can body;

FIG. 5 is a partially schematic perspective view of a processing station of the necker machine of FIGS. 1-3;

FIG. 6 is a partially schematic detail side elevation view of a portion of a processing station of a necker machine having a process air control arrangement in accordance with an example embodiment of the disclosed concept positioned on a process turret shaft of the processing station;

FIG. 7 is a further detail side elevation view of the process air control arrangement of FIG. 6 shown positioned relative to a portion of the process turret shaft of the processing station;

FIG. 8 is an elevation view of the end of the manifold housing of the process air control arrangement opposite the turret shaft;

FIG. 9A is a sectional view of the process air control arrangement and of FIGS. 7 and 10-12 taken along 9A-9A of FIG. 7;

FIG. 9B is a sectional view of the process air control arrangement of FIGS. 7 and 10-12 taken along 9B-9B of FIG. 7;

FIG. 9C is a sectional view of the process air control arrangement of FIGS. 7 and 10-12 taken along 9C-9C of FIG. 7;

FIG. 10 is a partially schematic perspective view of the process air control arrangement of FIG. 6 positioned on the process turret shaft of the processing station;

FIG. 11 is a side elevation view of the process air control arrangement of FIG. 7 shown positioned on the process turret shaft of the processing station and with a manifold housing of the process air control arrangement shown in dashed line so as to show details of internal elements of the process air control arrangement;

FIG. 12 is a perspective view of the process air control arrangement of FIG. 7 shown positioned on the process turret shaft of the processing station and with a manifold housing of the process air control arrangement shown in dashed line so as to show details of internal elements of the process air control arrangement; and

FIG. 13 is an isometric view of the process air control arrangement of FIGS. 6, and 10-12 showing details of the process turret facing end of the process air control arrangement.

### DETAILED DESCRIPTION OF THE INVENTION

It will be appreciated that the specific elements illustrated in the figures herein and described in the following specification are simply exemplary embodiments of the disclosed concept, which are provided as non-limiting examples solely for the purpose of illustration. Accordingly, specific dimensions, orientations, assembly, number of components used, embodiment configurations and other physical characteristics related to the embodiments disclosed herein are not to be considered limiting on the scope of the disclosed concept.

Directional phrases used herein, such as, for example, clockwise, counterclockwise, left, right, top, bottom, upwards, downwards and derivatives thereof, relate to the orientation of the elements shown in the drawings and are not limiting upon the claims unless expressly recited therein.

As used herein, the singular form of “a,” “an,” and “the” include plural references unless the context clearly dictates otherwise.

As used herein, “structured to [verb]” means that the identified element or assembly has a structure that is shaped, sized, disposed, coupled and/or configured to perform the identified verb. For example, a member that is “structured to move” is movably coupled to another element and includes elements that cause the member to move or the member is otherwise configured to move in response to other elements or assemblies. As such, as used herein, “structured to [verb]” recites structure and not function. Further, as used herein, “structured to [verb]” means that the identified element or assembly is intended to, and is designed to, perform the identified verb. Thus, an element that is merely capable of performing the identified verb but which is not intended to, and is not designed to, perform the identified verb is not “structured to [verb].”

As used herein, “associated” means that the elements are part of the same assembly and/or operate together, or, act upon/with each other in some manner. For example, an automobile has four tires and four hub caps. While all the elements are coupled as part of the automobile, it is understood that each hubcap is “associated” with a specific tire.

As used herein, a “fastener” is a separate component structured to couple two or more elements. Thus, for example, a bolt is a “fastener” but a tongue-and-groove coupling is not a “fastener.” That is, the tongue-and-groove elements are part of the elements being coupled and are not a separate component.

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other. As used herein, “adjustably fixed” means that two components are coupled so as to move as one while maintaining a constant general orientation or position relative to each other while being able to move in a limited range or about a single axis. For example, a doorknob is “adjustably fixed” to a door in that the doorknob is rotatable, but generally the doorknob remains in a single position relative to the door. Further, a cartridge (nib and ink reservoir) in a retractable pen is “adjustably fixed” relative to the housing in that the cartridge moves between a retracted and extended position, but generally maintains its orientation relative to the housing. Accordingly, when two elements are coupled, all portions of those elements are coupled. Further, an object resting on another object held in place only by gravity is not “coupled” to the lower object unless the upper object is otherwise maintained substantially in place. That is, for example, a book on a table is not coupled thereto, but a book glued to a table is coupled thereto.

As used herein, the phrase “removably coupled” or “temporarily coupled” means that one component is coupled with another component in an essentially temporary manner. That is, the two components are coupled in such a way that the joining or separation of the components is easy and would not damage the components. For example, two components secured to each other with a limited number of readily accessible fasteners, i.e., fasteners that are not difficult to access, are “removably coupled” whereas two components that are welded together or joined by difficult to access fasteners are not “removably coupled.”

As used herein, “operatively coupled” means that a number of elements or assemblies, each of which is movable between a first position and a second position, or a first configuration and a second configuration, are coupled so that as the first element moves from one position/configuration to the other, the second element moves between positions/configurations as well. It is noted that a first element may be “operatively coupled” to another without the opposite being true.

As used herein, the statement that two or more parts or components “engage” one another means that the elements exert a force or bias against one another either directly or through one or more intermediate elements or components. Further, as used herein with regard to moving parts, a moving part may “engage” another element during the motion from one position to another and/or may “engage” another element once in the described position. Thus, it is understood that the statements, “when element A moves to element A first position, element A engages element B,” and “when element A is in element A first position, element A engages element B” are equivalent statements and mean that element A either engages element B while moving to element A first position and/or element A either engages element B while in element A first position.

As used herein, “operatively engage” means “engage and move.” That is, “operatively engage” when used in relation to a first component that is structured to move a movable or rotatable second component means that the first component applies a force sufficient to cause the second component to move. For example, a screwdriver may be placed into contact with a screw. When no force is applied to the screwdriver, the screwdriver is merely “temporarily coupled” to the screw. If an axial force is applied to the screwdriver, the screwdriver is pressed against the screw and “engages” the screw. However, when a rotational force is applied to the screwdriver, the screwdriver “operatively engages” the screw and causes the screw to rotate. Further, with electronic components, “operatively engage” means that one component controls another component by a control signal or current.

As used herein, “correspond” indicates that two structural components are sized and shaped to be similar to each other and may be coupled with a minimum amount of friction. Thus, an opening which “corresponds” to a member is sized slightly larger than the member so that the member may pass through the opening with a minimum amount of friction. This definition is modified if the two components are to fit “snugly” together. In that situation, the difference between the size of the components is even smaller whereby the amount of friction increases. If the element defining the opening and/or the component inserted into the opening is/are made from a deformable or compressible material, the opening may even be slightly smaller than the component being inserted into the opening. With regard to surfaces, shapes, and lines, two, or more, “corresponding” surfaces, shapes, or lines have generally the same size, shape, and contours.

As used herein, the word “unitary” means a component that is created as a single piece or unit. That is, a component that includes pieces that are created separately and then coupled together as a unit is not a “unitary” component or body.

As used herein, the term “number” shall mean one or an integer greater than one (i.e., a plurality). That is, for example, the phrase “a number of elements” means one element or a plurality of elements. It is specifically noted that the term “a ‘number’ of [X]” includes a single [X].

As employed herein, the terms “can” and “container” are used substantially interchangeably to refer to any known or suitable container, which is structured to contain a substance (e.g., without limitation, liquid, food, any other suitable substance), and expressly includes, but is not limited to, beverage cans, such as beer and beverage cans, as well as food cans.

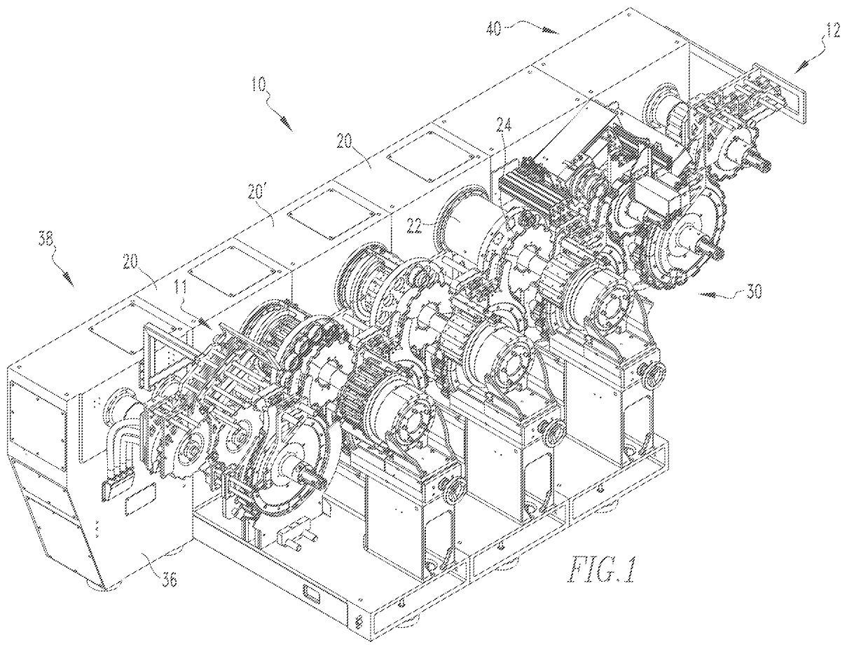

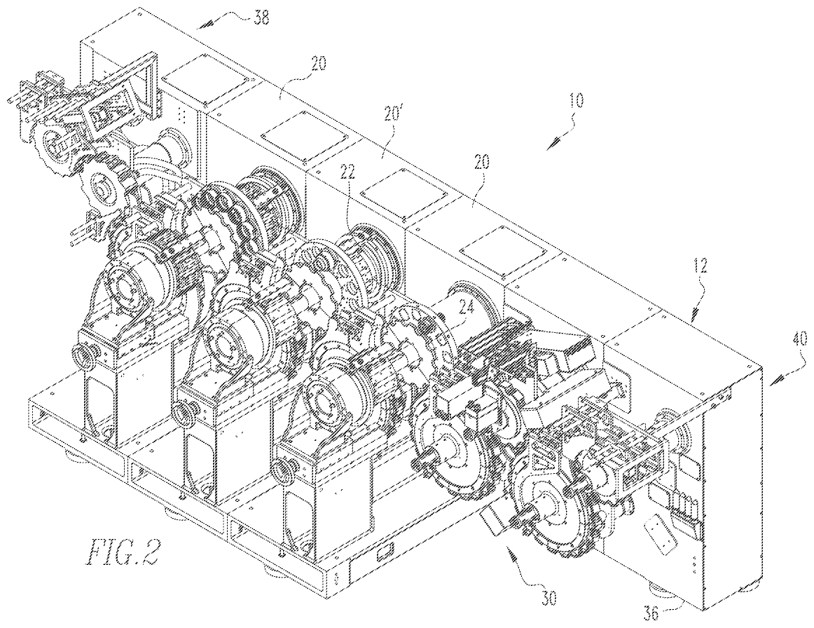

As shown in FIGS. 1-3, a necker machine 10 is structured to reduce the diameter of a portion of a can body 1. Necker machine 10 is of similar construction and operates in a similar manner as necker machines described in U.S. Pat. Nos. 11,370,015 and 11,565,303 commonly assigned to the same assignee as the present application except for the process air control arrangements 100 described herein and components related thereto. Accordingly, only a general overview of major components of necker machine 10 and the general operation thereof is provided herein.

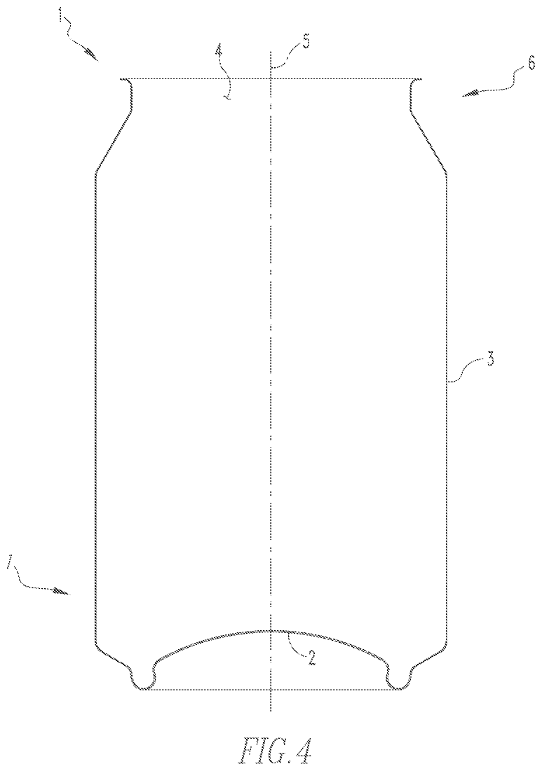

As used herein, to “neck” means to reduce the diameter/radius of a portion of a can body 1. That is a can body 1, such as shown (for example, without limitation) in FIG. 4, includes a base 2 with an upwardly depending sidewall 3. The base 2 and sidewall 3 define a generally enclosed space 4. In the embodiment discussed below, the can body 1 is a generally circular and/or an elongated cylinder. It is understood that this is only one exemplary shape and that the can body 1 can have other shapes. The can body 1 has a longitudinal axis 5. The sidewall 3 has a first end 6 and a second end 7. The base 2 is at the second end 7 and the first end 6 is open. The first end 6 initially has substantially the same radius/diameter as the sidewall 3, however following forming operations in the necker machine 10, the radius/diameter of the first end 6 is smaller than the other portions of the radius/diameter at the sidewall 3.

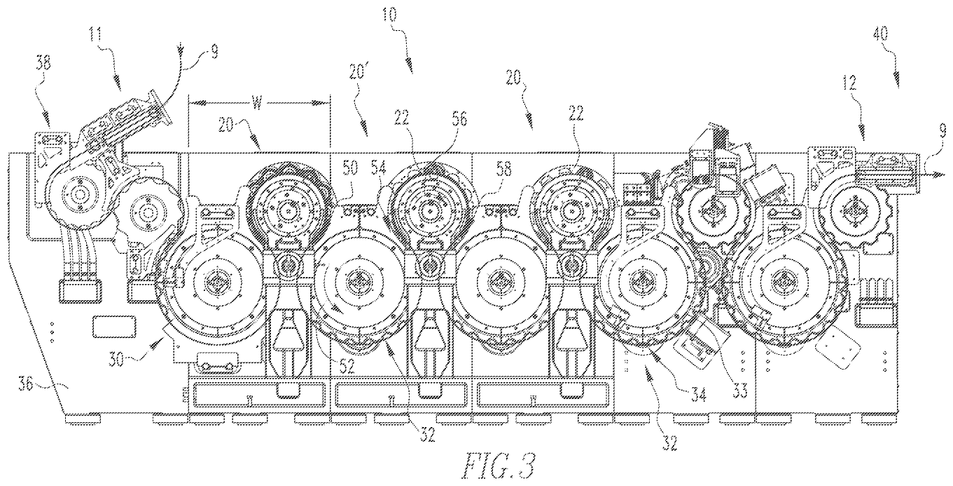

The necker machine 10 includes an infeed assembly 11, a plurality of processing/forming stations 20, a transfer assembly 30, and a drive assembly (not numbered). Hereinafter, processing/forming stations 20 are identified by the term “processing stations 20” and refer to generic processing stations 20. As is known, the processing stations 20 are disposed adjacent to each other and in series. That is, the can bodies 1 being processed by the necker machine 10 each move from an upstream location through a series of processing stations 20 in the same sequence. The can bodies 1 follow a path, hereinafter, the “work path 9” (FIG. 3). That is, the necker machine 10 defines the work path 9 wherein can bodies 1 move from an “upstream” location to a “downstream” location; as used herein, “upstream” generally means closer to the infeed assembly 11 and “downstream” means closer to an exit assembly 12. With regard to elements that define the work path 9, each of those elements have an “upstream” end and a “downstream end” wherein the can bodies move from the “upstream” end to the “downstream end.” Thus, as used herein, the nature/identification of an element, assembly, sub-assembly, etc. as an “upstream” or “downstream” element or assembly, or, being in an “upstream” or “downstream” location, is inherent. Further, as used herein, the nature/identification of an element, assembly, sub-assembly, etc. as an “upstream” or “downstream” element or assembly, or, being in an “upstream” or “downstream” location, is a relative term.

Each processing station 20 has a similar width W (FIG. 3) and the can body 1 is processed and/or formed (or partially formed), i.e., “necked”, as the can body 1 moves across the width. Generally, the processing/forming occurs in/at a turret 22. That is, the term “turret 22” identifies a generic turret. Each processing station 20 includes a non-vacuum starwheel 24. As used herein, a “non-vacuum starwheel” means a starwheel that does not include, or is not associated with, a vacuum assembly that is structured to apply a vacuum to the starwheel pockets. Further, each processing station 20 typically includes one turret 22 and one non-vacuum starwheel 24.

The transfer assembly 30 is structured to move the can bodies 1 between adjacent processing stations 20. The transfer assembly 30 includes a plurality of vacuum starwheels 32. As used herein, a “vacuum starwheel” means a starwheel assembly that includes, or is associated with, a vacuum assembly that is structured to apply a vacuum to the starwheel pockets 34. Further, the term “vacuum starwheel 32” identifies a generic vacuum starwheel 32. A vacuum starwheel 32 includes disk-like body (FIG. 3) or disk-like body assembly, and a plurality of pockets 34 disposed on the radial surface of the disk-like body 33. When used in association with generally cylindrical can bodies 1, the pockets 34 are generally semi-cylindrical. A vacuum assembly (not numbered), selectively applies suction to the pockets 34 and is structured to selectively couple a can body 1 to a pocket 34. It is understood, and as used herein, that “to apply a vacuum to a pocket 34” means that a vacuum (or suction) is applied to a starwheel pocket via at least one suitable passage. As such, components of the transfer assembly 30 such as, but not limited to, the vacuum starwheels 32 are also identified as parts of the processing stations 20. Conversely, the non-vacuum starwheel 24 of the processing stations 20 also move the can bodies 1 between processing stations 20 so the non-vacuum starwheels 24 are also identified as part of the transfer assembly 30.

It is noted that the plurality of processing stations 20 are structured to neck different types of can bodies 1 and/or to neck can bodies in different configurations. Thus, the plurality of processing stations 20 are structured to be added and removed from the necker machine 10 depending upon the need. To accomplish this, the necker machine 10 includes a frame assembly 36 to which the plurality of processing stations 20 are removably coupled. Alternatively, the frame assembly 36 includes elements incorporated into each of the plurality of processing station 20 so that the plurality of processing stations 20 are structured to be temporarily coupled to each other. The frame assembly 36 has an upstream end 38 and a downstream end 40. Further, the frame assembly 36 includes elongated members, panel members (neither numbered), or a combination of both. As is known, panel members coupled to each other, or coupled to elongated members, form a housing. Accordingly, as used herein, a housing is also identified as a “frame assembly 36.”

Generally, each processing station 20 is structured to partially form (i.e., neck) the can body 1 so as to reduce the cross-sectional area of the can body first end 6 a predetermined amount. The processing stations 20 include some elements that are unique to a single processing station 20, such as, but not limited to, a specific die. Other elements of the processing stations 20 are common to all, or most, of the processing stations 20. The following discussion is related to the common elements and, as such, the discussion is directed to a single generic processing (forming) station 20′ of the processing stations 20. It is understood, however, that any processing station 20 can include the elements discussed below.

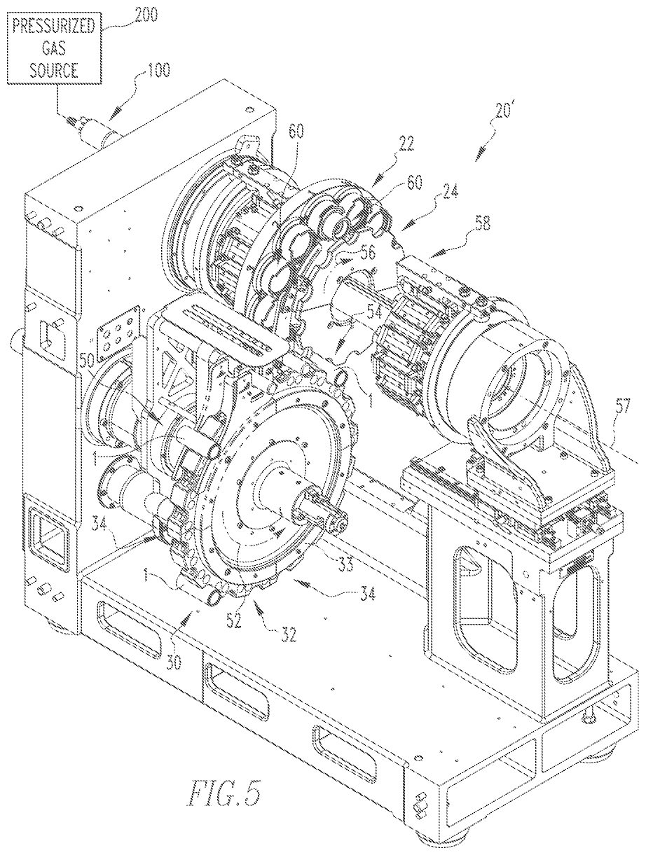

Referring generally now to the isolated view of the representative processing station 20′ of FIG. 5 (in addition to FIG. 3), during necking operations, a can body 1 is received in a pocket 34 of the vacuum starwheel 32 of the processing station 20′ generally at a receiving point, such as generally indicated at 50. Depending on the positioning of the processing station, the can body 1 received at 50 may be received from an infeed assembly 11 or from a non-vacuum starwheel 24 of an adjacent processing station 20. The can body 1 moves with pocket 34 as the vacuum starwheel 32 rotates in a direction as shown by the arrow 52, until the can body 1 reaches a transfer point, such as generally indicated at 54, wherein the can body 1 transfers from the vacuum starwheel 32 to the non-vacuum starwheel 24 of the turret 22. The can body 1 then moves with the non-vacuum starwheel 24 as it rotates in a direction as shown by the arrow 56 about a rotation axis 57, until the can body 1 reaches another transfer point, such as generally shown at 58, wherein the (now partially necked) can body 1 is transferred to the vacuum starwheel 32 of an adjacent downstream processing station 20. Accordingly, it is to be appreciated that transfer points 50 and 58 correspond among each processing station 20 of the necker machine 10.

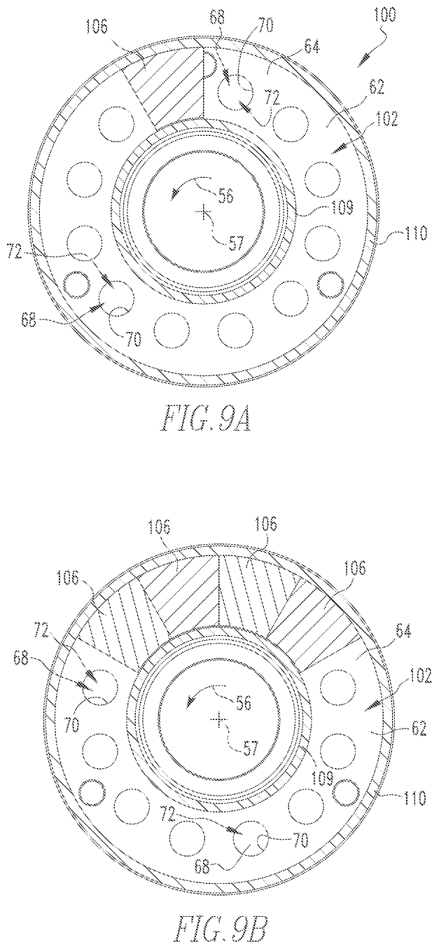

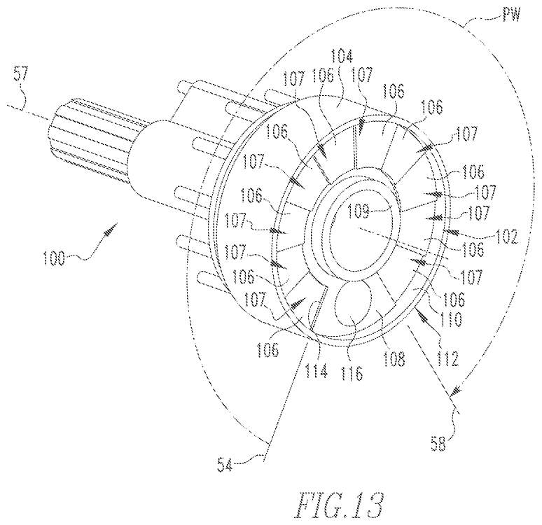

As alluded to above, as the can body 1 moves from transfer point 54 to transfer point 58, the can body 1 is partially necked a predetermined amount by selectively moving the can body 1, and more particularly the open first end 6 (FIG. 4) of the can body 1 into engagement with a respective forming die assembly or forming die 60 (either referred to herein simply as “forming die 60”) of a plurality of forming dies 60 of the turret 22 and then subsequently disengaging the can body 1 from the respective forming die 60 prior to transfer from the starwheel 24. Such portion of the travel of a can body 1 about turret 22 is commonly referred to as the necking process window PW (FIGS. 9C and 13). Although the passage of a single can body 1 has been described, it is to be appreciated that in operation a stream of can bodies 1 positioned in the adjacent pockets of the starwheels 32 and 24 would pass through the processing station 20′. Accordingly, at any given time several can bodies 1 are passing between transfer points 54 and 58 and thus each being necked by a respective forming die 60 with which each can body 1 is engaged and subsequently disengaged during such time.

As is known, it is desirable to apply positive pressure to the interior of the can bodies 1 as the can bodies 1 are being formed by the dies 60 of the forming station 20′ while passing through the aforementioned necking process window PW. The positive pressure helps the can bodies 1 resist damage during forming/necking. Unlike prior arrangements, embodiments of the disclosed concept provide for precise control of the can necking process by selectively controlling/manipulating the pressure of air provided to/present within a can body 1 as the can body 1 is formed/necked while passing through the necking process window PW. By selectively controlling/manipulating the air pressure during the forming/necking process, arrangements in accordance with the disclosed concept serve to reduce overall machine air consumption by enabling airflow to be reduced in areas of the necking process window PW where the full available supply pressure is not needed. By reducing air consumption, the amount of energy required to form/neck the can bodies 1 by necker machine 10 is also reduced.

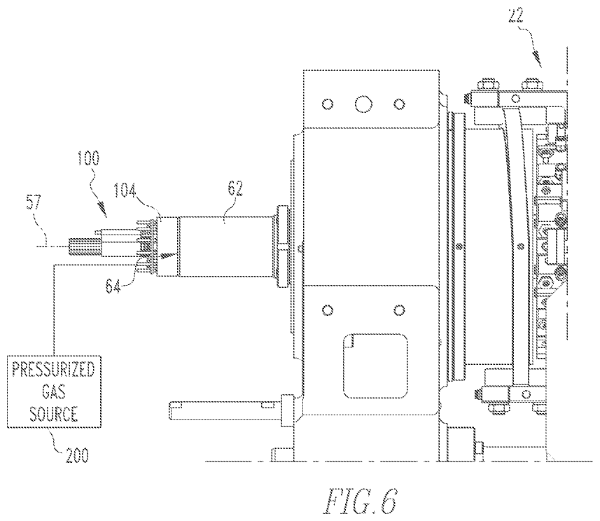

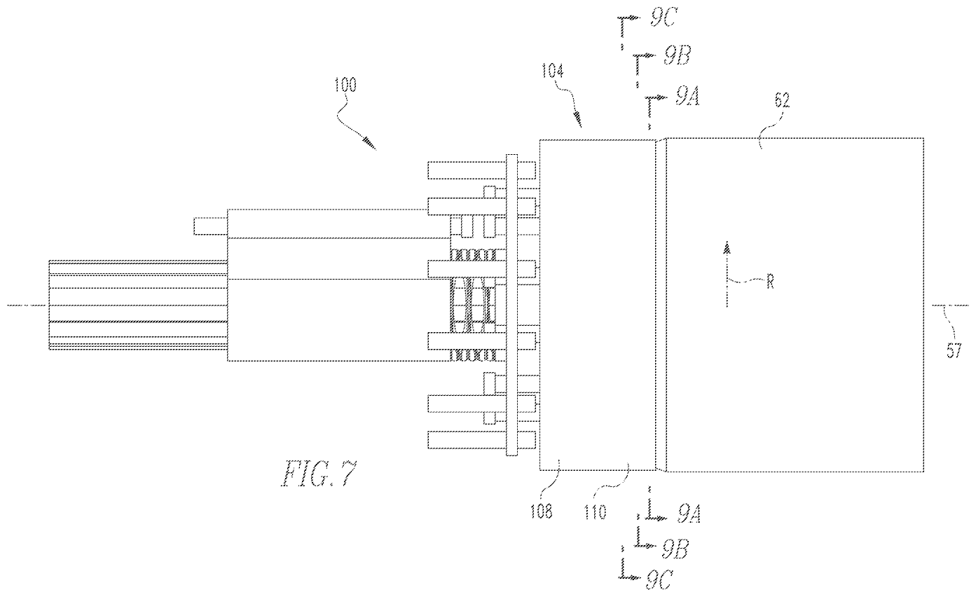

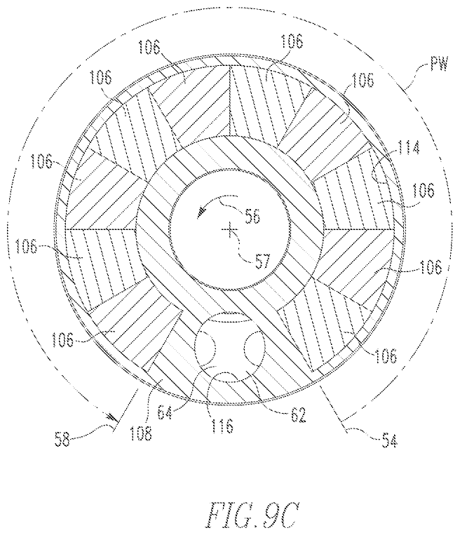

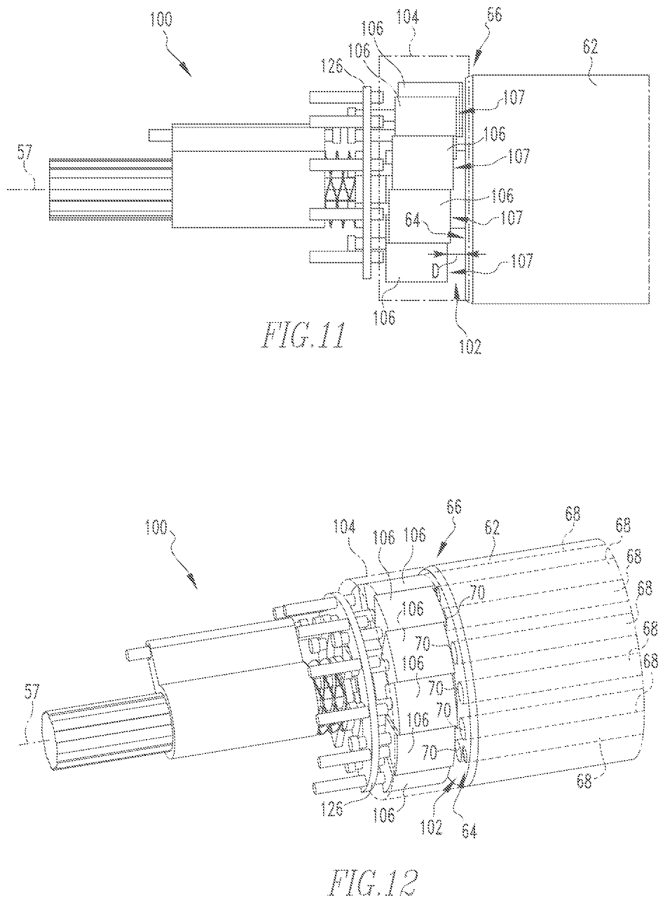

Continuing to refer to FIG. 5, and additionally FIG. 6 onward, a process air control arrangement 100 in accordance with an example embodiment of the disclosed concept will now be described. The process air control arrangement 100 controls the flow/pressure of air provided to the forming dies 60 of turret 22 from a pressurized gas source 200 (e.g., without limitation, an air compressor). More particularly, the process air control arrangement 100 controls the flow/pressure of air passing from a manifold volume 102 (FIGS. 9A, 9B, 11-13), supplied by the pressurized gas source 200, which generally serves as a junction in the air flow pathway between non-rotating parts of the necker machine 10 and a rotating (such as shown by the arrow R in FIGS. 7 and 10, as well as arrow 57 in FIGS. 5 and 9A-9C) process shaft 62 which extends from turret 22 and is driven/rotates during operation of the necker machine 10 about the axis 57. As discussed in greater detail below, the manifold volume 102 is defined between portions of the air control arrangement 100 and a portion of the process shaft 62. It is to be appreciated, that any suitable compressed air source 200 may be employed, hence compressed air source 200 is shown schematically in the Figures and particular details thereof are not provided herein.

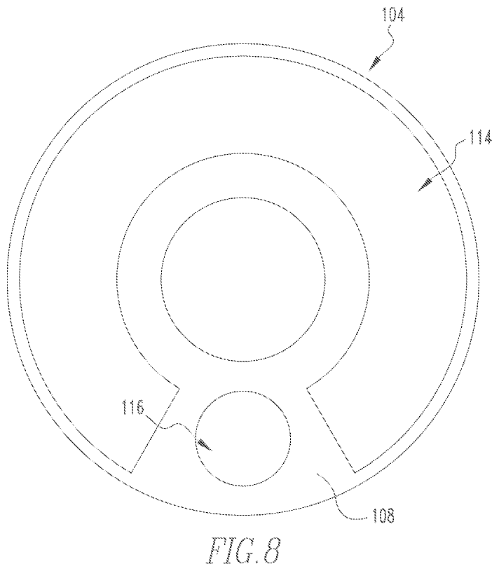

The process air control arrangement 100 includes a manifold housing 104 and a plurality of manifold keys 106, each key 106 being selectively positionable with respect to the manifold housing 104 as discussed further below. The manifold housing 104 includes a main body portion 108, and inner and outer skirt portions 109 and 110, each extending from the main body portion 108 to a distal ends (only the distal end 112 of outer skirt portion 112 is numbered, e.g., see FIG. 10) that are structured to sealingly engage the process shaft 62. The main body portion 108 includes a number of apertures 114 defined therethrough, with each aperture 114 being sized and configured to have at least one manifold key 106 slidingly engaged therein. In the example embodiment illustrated in FIGS. 6-13, the main body portion 108 includes a single generally crescent-shaped aperture 114 having ten generally wedge-shaped manifold keys 106 positioned therein, however, it is to be appreciated that other combinations of apertures 114 and manifold keys 106 may be utilized without varying from the scope of the disclosed concept. For example, in another embodiment of the disclosed concept, the main body portion 108 includes a plurality of apertures 114, with each aperture 114 having a single manifold key 106 positioned therein. In yet another example embodiment, the main body portion 108 includes a plurality of apertures 114, with each aperture 114 having a plurality of manifold keys 106 positioned therein. It is also to be appreciated that one or more of the shape, size (e.g., the angular spacing from one edge to the other) and/or quantity of manifold keys 106 and aperture(s) 114 in which the manifold keys 106 employed may be varied without varying from the scope of the disclosed concept. Further, it is to be appreciated that manifold keys 106 and/or apertures of different shapes/sizes may also be employed without varying from the scope of the disclosed concept.

The manifold housing 104 and manifold keys are structured to be coupled adjacent the end 66 of the process shaft 62 via any suitable arrangement such that when the manifold housing 104 and the manifold keys 106 are positioned adjacent the process shaft 62 portions of the manifold housing 104 and the manifold keys along with a portion of the process shaft 62 create a manifold (not numbered) that defines the manifold volume 102. In the example embodiment illustrated in FIGS. 6-13, the manifold volume is defined generally by a portion of the main body portion 108, the inner and outer skirt portions 109 and 110, and a face 64 positioned at the end 66 of the process shaft 62. The manifold volume 102 is supplied pressurized gas (e.g., air) from the pressurized gas source 200 (e.g., via anu suitable communication arrangement) via an inlet port 116 defined in the manifold housing 104.

As previously provided, the process air control arrangement 100 controls the flow/pressure of air from the pressurized gas source 200 provided to the forming dies 60 from the manifold volume 102. More particularly, each of the manifold keys 106 serve to selectively throttle/control the flow of air from the manifold volume 102 entering a number of passage(s) 68 defined in the process shaft 62 when such passage(s) are positioned adjacent the respective manifold key 106. In the example embodiment illustrated in FIGS. 6-13, the process shaft 62 includes twelve of such passages 68 that each extend from a respective opening 70 defined in the end 64 of shaft 62 toward a respective one of the forming dies 60 of turret 22. Each of such passages 68 defined in shaft 62 is coupled with a number of further suitable conduit portions (not numbered) to form continuous passages 72 that each extend from a respective opening 70 to a respective forming die 60 such that each passage 72 is structured to convey a flow of gas from one of the openings 70 to one of the forming dies 60 of the turret 22. In other words, each opening 70 corresponds to one passage 72 that is structured to convey air to only one forming die 60. As shown in FIG. 9A, the openings 70 are positioned generally equidistant from, and clocked about, the rotational axis 57 of the process shaft 62 such that the positioning of each opening 70 corresponds to the positioning of the forming die 60 fed by the passage 72 thereof. In other words, in the view of FIG. 9A: an opening 70 positioned near the top at about the 12:30 position (i.e., about to reach the top as the process shaft 62 rotates about axis 57) corresponds to a forming die 60 positioned at about the 11:30 position (i.e., about to reach the top as the process shaft 62 rotates about axis 57) when viewed facing the opening of the forming die (i.e., the can body insertion side); while an opening 70 positioned near the bottom at about the 5:30 position (i.e., just past the bottom due to rotation of the process shaft 62) corresponds to a forming die 60 positioned at about the 6:30 position (i.e., just past the bottom when viewed facing the opening of the forming die); and so on for each of the other openings 70. Such relationships between each opening 70 and corresponding forming die 60 are fixed such that when the process shaft 62 rotates about the rotational axis 57, the openings 70, passages 68/72 and forming dies 60 all rotate about the rotational axis 57 in a fixed manner (e.g., when an opening 70 starting at the 12 o'clock position in FIG. 9A has rotated to the bottom, the corresponding forming die 60 has also rotated to the bottom). Accordingly, FIGS. 9C and 13 show the relative angular positioning of the previously discussed transfer points 54 and 58 of cans to/from starwheel 24 of turret 22 as well as the region of the necking process window PW.

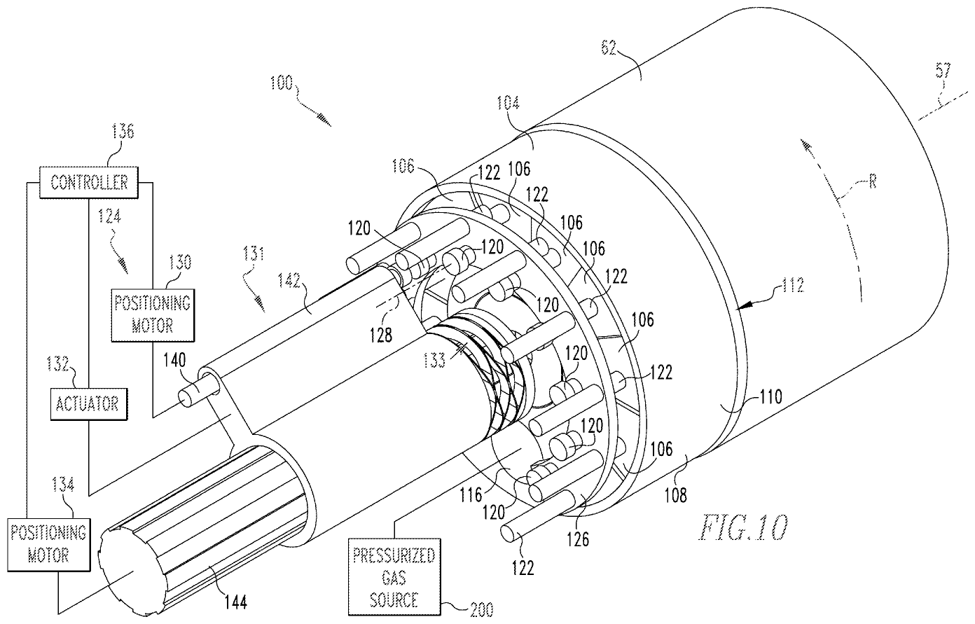

As shown in FIG. 9C, each of the manifold keys 106 (which are coupled to frame assembly 36 so as to not rotate about the axis 57) are positioned with respect to the manifold housing 104 (e.g., main body 108 of manifold housing 104) such that when the manifold housing 104 is positioned adjacent the end 66 of the shaft 62 each of the manifold keys 60 are positioned about the axis 57 so as to correspond to different angular segments (not numbered) of the processing window PW about the axis 57. While the angular positioning about each manifold key 106 is fixed, the positioning of each manifold key 106 along axis 57 is adjustable such that each key 106 may be selectively positioned an adjustable separation distance D (FIG. 11) from the face 64 of the shaft 62, and thus also spaced such distance D from the opening(s) 70 of a passage 68/72 rotationally positioned in a corresponding angular positioning about the axis 57 as the particular manifold key 60. More particularly, each manifold key 60 is structured to be selectively positioned such that the separation distance D of an end face 107 thereof from the face 64/openings 70 can be selectively varied by moving the manifold key toward or away from the face 64, and in doing so selectively affecting the passage of air from the manifold volume 102 into the passage(s) 68/72 of the opening(s) 70 positioned adjacent the particular manifold key 60.

In the example embodiment shown in FIGS. 6-13, positioning of each of the manifold keys 106, and thus the separation distance D from the end face 107 of each manifold key 106 from the face 64 of the shaft 62, is controlled with a negative feedback loop by the combination of an adjustment screw 120 and a position sensor 122 associated with each manifold key 60, and an adjustment arrangement 124 structured to selectively adjust each adjustment screw 120 about an adjustment axis 128. In such embodiment, each adjustment screw 120 is rotatably coupled at a first end thereof to a manifold key 106 so as to freely rotate with respect thereto while also threadingly engaged generally at a mid-point of the adjustment screw 120 with a retention plate 126 that is fixedly coupled with respect to the manifold housing 104 such that rotation of the adjustment screw 120 about an adjustment axis 128 of the adjustment screw 120 results in the positioning of the screw 120, and thus the first end thereof (along with the rotatably coupled manifold key 106) to be selectively adjusted with respect to the retention plate 126 (and thus the manifold housing 104 and the face 64 of the shaft 62). The adjustment arrangement 124 includes a number of positioning motors (e.g., positioning motor 130—shown schematically in FIG. 10) structured to engage a second end of each adjustment screw 120 opposite the first end via a suitable engagement arrangement 131 in a manner such that each adjustment screw 120 may be selectively rotated via the positioning motor.

Due to the relatively high cost of adjustment motors, one example embodiment of the disclosed concept, such as the example shown in FIG. 10, provides for the full array of manifold keys 106 to be adjusted using only two positioning motors 130 and 134 (shown schematically) along with one linear actuator 132 (also shown schematically), with the selective positioning of each controlled by a controller 136 (e.g., any suitable controller structured to receive, process and transmit signals to selectively control components) in communication with each of the aforementioned elements. In such example embodiment the engagement arrangement 131 of the adjustment arrangement 124 includes an adjustor spindle 140 carried by and rotatably coupled with a carrier member 142 such that the adjustor spindle 140 can only rotate (e.g., about an axis 128 of a selected adjustment screw 120) but not move in any other manner with respect to the carrier member 142. The carrier member 142 is coupled about a central member 144 that is rotatably fixed along the axis 57 (e.g., can only rotate about axis 57) via any suitable arrangement. More particularly, the carrier member 142 is slidably coupled to the central member 144 such that the carrier member 142 can slide/translate along the central member 144 (and along axis 57) but not rotate independently from central member 144 (i.e., carrier member 142 can only rotate about axis 57 if/when central member 144 rotates about the axis 57). In the example embodiment illustrated in FIGS. 10-13, central member 144 is shown as an outwardly splined member which interacts with a correspondingly inwardly splined portion (not numbered) of the carrier member 142, however, it is to be appreciated that any other suitable arrangement (e.g., keyed) which limits the movement of carrier member 142 to only being slidable along central member 144 may be employed without varying from the scope of the disclosed concept. The adjustor spindle 140 may be selectively engaged/disengaged (i.e., translated toward/away from) with a particular adjustment screw 120. Engagement with a particular adjustment screw 120 is controlled by the linear actuator 132 (provided as an element of the adjustment arrangement 124) translating the carrier member 142, and thus the spindle member 140, along the central member 144 toward the particular adjustment screw; while disengagement with the particular adjustment screw 120 is provided by a return spring 133. In other words, when energized, the actuator 132 causes the carrier member 142, and thus the adjustor spindle 140 rotatably coupled therewith, to move toward the adjustment screw 120. When the actuator 132 is not energized, the return spring 134 causes the carrier member 142, and thus the adjustor spindle 140, to move away from the adjustment screw 120. The adjustor spindle 140 is selectively rotated by the positioning motor 130 when the adjustor spindle 140 is engaged with an adjustment screw 120. The second positioning motor 134 provides for the rotational positioning of the carrier member 142, and thus the adjustor spindle 140 when disengaged with an adjustment screw 120, to be adjusted so as to provide for selection of a particular adjustment screw 120 among the plurality of adjustment screws 120 (and thus the associated manifold key 106) to be selectively adjusted. When not engaged by the adjustor spindle, a friction element (not numbered) acting on the adjustor screw(s) 120 prevent any unintended motion/displacement of the adjustment screw(s) 120/manifold key(s) 106. While such example embodiment does not provide for the position of the manifold keys 106 to be manipulated simultaneously, such embodiment can save substantial cost when a large number of manifold keys 106 are needed to precisely control the air pressure distribution through the necking process.

From the foregoing description, it is to be appreciated that several elements of the disclosed concept may be varied without varying from the scope thereof. For example, the number of manifold keys 106, and thus the accompanying adjustment arrangements may be varied without varying from the scope of the disclosed concept as fewer manifold keys 106 and related elements would be a less expensive implementation, but more manifold keys 106 would provide more discrete control of smaller portions of the necking process window PW.

As another example, the adjustment arrangement 124 may be varied to employ a different quantity of motors 130, 134 and/or actuator(s) 132 than particularly described herein and/or how such motors are arranged (e.g., without limitation, a motor directly driving each adjustment screw). Further such motors may be servo motors, stepper motors, or some other type of positioning motor without varying from the scope of the disclosed concept, while the linear actuator(s) may be electric, pneumatic, or some other type of linear positioning motor.

As a further example, the plurality of sensors 122 used to detect the position of each adjustment key 106 may be varied depending on the quantity of adjustment keys 106 employed and/or the sensors 122 may be eliminated by the use of control logic by the controller 136. For example, by employing a friction clutch or similar arrangement in the arrangement between positioning motor 130 and the adjustment screw 120 being adjusted, the positioning motor 130 can drive the adjustment screw 120 and thus the corresponding manifold key 106 until the key 106 bottoms out on the shaft and the friction clutch slips. From here, the positioning motor 130 can back the manifold key 106 a desired separation distance D (FIG. 11) from the face 64 of the process shaft 62 by a specified amount based on the quantity of rotations of the positioning motor 130 and the lead angle of the thread of the adjustment screw 120. Such arrangement provides options for either closed or open loop control.

As yet another example, the manifold housing 104, manifold keys 106, and related components may be shaped/situated to vary positioning of the manifold keys with openings provided extending in the radial outer surface (not numbered) of the shaft 62 as opposed to the end surface 64. In such embodiment(s), the manifold keys 106 may be constrained so as to be adjustable radially toward or away from the axis 57 without being moveable along axis 57, thus providing for the distance (similar to the separation distance D in FIG. 11) between the outward facing openings in the shaft 62 and the inward facing surfaces (curved in such example) of the manifold keys to be selectively varied.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

What is claimed is:

1. A process air control arrangement for a processing station of a necker machine having a frame assembly and a process shaft which rotates during operation of the processing station, the process shaft having a plurality of forming dies coupled thereto and having a plurality of openings defined at or about an end thereof, each opening having a passage extending therefrom to a respective forming die of the plurality of forming dies for providing a flow of gas from the opening to the respective forming die, the process air control arrangement comprising:
a manifold housing; and
a plurality of manifold keys, each manifold key selectively positionable with respect to the manifold housing,
wherein the manifold housing is structured to be fixedly coupled to the frame assembly, and
wherein when the manifold housing and the manifold keys are positioned adjacent the process shaft:
portions of the manifold housing and the manifold keys along with a portion of the process shaft define a manifold volume structured to receive a supply of pressurized gas via an inlet, and
each manifold key is selectively positioned an adjustable distance from at least one opening of the plurality of openings so as to selectively affect passage of air into the passage extending from the at least one opening from the manifold volume when the supply of pressurized gas is received by the manifold volume.

2. The process air control arrangement of claim 1, wherein each manifold key is selectively positionable with respect to the manifold housing via an adjustment arrangement.

3. The process air control arrangement of claim 2, wherein the adjustment arrangement comprises an adjustment screw.

4. The process air control arrangement of claim 3, further comprising a key adjuster selectively moveable among the adjustment screw of each manifold key of the plurality of manifold keys, the key adjuster structured to selectively engage and rotate each adjustment screw.

5. The process air control arrangement of claim 1, wherein the manifold housing comprises:
a main body portion having a number of apertures defined therethrough, wherein each aperture has at least one manifold key of the plurality of manifold keys slidingly engaged therein; and
an outer skirt portion extending from the main body portion to a distal end, the distal end of the outer skirt portion being structured to sealingly engage the process shaft.

6. The process air control arrangement of claim 5, wherein the manifold housing further comprises an inner skirt portion extending from the main body portion to a distal end, the distal end of the inner skirt portion being structured to sealingly engage the process shaft.

7. The process air control arrangement of claim 5, wherein the number of apertures comprises a single aperture with all of the plurality of manifold keys slidingly engaged therein.

8. The process air control arrangement of claim 5, wherein the number of apertures comprises a plurality of apertures.

9. The process air control arrangement of claim 8, wherein each aperture has only one manifold key slidingly engaged therein.

10. The process air control arrangement of claim 1, further comprising a retention plate and a plurality of adjustment screws, wherein each adjustment screw is engaged among the retention plate and a respective manifold key of the plurality of manifold keys in a manner such that when the manifold housing and the manifold keys are positioned adjacent the process shaft, and wherein rotation of each adjustment screw about an adjustment axis thereof provides for the selective adjustment of a separation distance between the respective manifold key and a face of the process shaft.

11. The process air control arrangement of claim 10, further comprising an adjustment arrangement structured to selectively adjust each adjustment screw of the plurality of adjustment screws.

12. The process air control arrangement of claim 11, wherein the adjustment arrangement comprises a first positioning motor structured to engage a second end of each adjustment screw opposite a first end engaged with the respective manifold key via a suitable engagement arrangement in a manner such that each adjustment screw may be selectively rotated via the first drive motor.

13. The process control arrangement of claim 10, wherein:
the adjustment arrangement further comprises:
a second positioning motor, and
an actuator;
the engagement arrangement includes:
a central member structured to be rotatably coupled to the frame assembly so as to be rotatable about a common axis with the process shaft;
a carrier member slidably coupled to the central member so as to be slidable along the central member but otherwise fixed therewith; and
an adjustor spindle carried by, and rotatably coupled with the carrier member;
the second positioning motor is operatively coupled to the carrier member so as to provide for selective rotation of the carrier member about the common axis to position the adjustor spindle in axial alignment with a selected adjustment screw of the plurality of adjustment screws; and
the actuator is operatively coupled with the carrier member so as to provide for selective translation of the carrier member on the splined member along the common axis.

14. A processing station for a necker machine, the processing station comprising:
a frame assembly;
a process shaft rotatably coupled to the frame assembly, the process shaft structured to rotate during operation of the processing station;
a turret fixedly coupled to the process shaft, the turret having a plurality of forming dies coupled thereto; and
a process air control arrangement,
wherein the process shaft comprises a plurality of openings defined at or about an end thereof, each opening having a passage extending therefrom to a respective forming die of the plurality of forming dies for providing a flow of gas from the opening to the respective forming die,
wherein the process air control arrangement comprises:
a manifold housing; and
a plurality of manifold keys, each manifold key selectively positionable with respect to the manifold housing,
wherein the manifold housing is fixedly coupled to the frame assembly,
wherein portions of the manifold housing and the manifold keys along with a portion of the process shaft define a manifold volume structured to receive a supply of pressurized gas via an inlet, and
wherein each manifold key is selectively positioned an adjustable distance from at least one opening of the plurality of openings so as to selectively affect passage of air into the passage extending from the at least one opening from the manifold volume when the supply of pressurized gas is received by the manifold volume.

15. A necker machine for necking can bodies, the necker machine comprising a plurality of processing stations, each processing station comprising:
a frame assembly;
a process shaft rotatably coupled to the frame assembly, the process shaft structured to rotate during operation of the processing station;
a turret coupled fixedly coupled to the process shaft, the turret having a plurality of forming dies coupled thereto; and
a process air control arrangement,
wherein the process shaft comprises a plurality of openings defined at or about an end thereof, each opening having a passage extending therefrom to a respective forming die of the plurality of forming dies for providing a flow of gas from the opening to the respective forming die,
wherein the process air control arrangement comprises:
a manifold housing; and
a plurality of manifold keys, each manifold key selectively positionable with respect to the manifold housing,
wherein the manifold housing is fixedly coupled to the frame assembly,
wherein portions of the manifold housing and the manifold keys along with a portion of the process shaft define a manifold volume structured to receive a supply of pressurized gas via an inlet, and
wherein each manifold key is selectively positioned an adjustable distance from at least one opening of the plurality of openings so as to selectively affect passage of air into the passage extending from the at least one opening from the manifold volume when the supply of pressurized gas is received by the manifold volume.
